(19) United States
(12) Patent Application Publication
(10) Pub. No.: US 2022/0228619 A1
(43) Pub. Date: Jul. 21, 2022

(54) FASTENING ELEMENT FOR INCREASING FIXING STABILITY

(71) Applicant: Ha Chul JEUN, Busan (KR)

(72) Inventor: Ha Chul JEUN, Busan (KR)

(21) Appl. No.: 17/433,344

(22) PCT Filed: Sep. 18, 2020
(86) PCT No.: PCT/KR2020/012650

§ 371 Date: Aug. 24, 2021

(30) Foreign Application Priority Data
Oct. 7, 2019 (KR) 10-2019-0123639

(51) Int. Cl. F16B 25/10

(52) U.S. Cl. CPC F16B 25/106

(57) ABSTRACT

The present invention provides a fastening element for increasing fixing stability, the fastening element having a drill part formed at the bottom tip of the lower end of a fixing piece so that a fixing groove can be easily formed by means of the drill part when the fixing groove is formed on a structure, wherein one side of the drill part is formed to be pointed and the other side thereof is formed to be blunt so that the fastening element is easily screw-fastened to the fixing groove of the structure and, simultaneously, can be prevented from being loosened by external vibration and the like. The present invention has a protruding part protruding downward from the lower surface of a flange, so that the protruding part is pressed and fixed to the upper surface of the structure so as to enable the fastening element to be more firmly fixed to the structure. In addition, a polygonal upper flange is formed on the upper surface of the flange, and thus a fastening part or the upper flange of the fixing piece is fastened using a wrench and the like, so that the fastening element can be easily fixed onto the structure.

### TECHNICAL FIELD

The present invention relates to a fastening element for increasing fixing stability in which a drill section is formed at a bottom tip of a lower end of a fixture so that a fixing recess can be easily formed on a structure by the drill section, and in which a cut-out part is formed on the lower end of the fixture in such a manner as to be formed sharp at one side thereof and formed blunt at the other side thereof so that the fastening element can be easily screw-fastened to the fixing recess of the structure and simultaneously can be prevented from being loosened due to external vibration and the like.

### BACKGROUND ART

In general, a fixing element used to fix a scaffolding for working, and the like is inserted into a bore-hole drilled previously in a rigid bottom such as wall, concrete, rock or the like or a fixing plate so as to be coupled to the bottom or the fixing plate. As a prior art associated with such a fixing element, Korean Patent Laid-Open Publication No. 10-2002-0083917 entitled “Fixing Element” and Korean Patent Laid-Open Publication Nos. 10-2014-0064977 entitled “Fastening System” have been proposed.

Korean Patent Laid-Open Publication No. 10-2002-0083917 discloses a general fixing element configured to be inserted into a bore-hole drilled previously in a rigid bottom such as concrete, rock, steel or the like using a setting device driven by high-pressure gas, the fixing element including a shaft 1, 11 or 21 having a free end formed flatly and a load acting means 2, 12 or 22, wherein the external contour of the shaft 1, 11 or 21 is formed in a cylindrical shape. In addition, Korean Patent Laid-Open Publication Nos. 10-2014-0064977 discloses a fastening system 1 configured to fix an accessory part 14 to a setting object 17 by means of a setting bolt 2, the fastening system which includes: the setting bolt 2 formed with a first end 3 and a second end 4 and having a fixed region 5 and a load applying region 6; a ring- or sleeve-shaped sealing element 10 having an opening 13 formed therein to seal the setting bolt 2 to be inserted into the setting object 17; and the accessory part 14, for example, a grating plate, an electric fastening device or a spacer that is configured to be fixed to the load applying region 6 of the setting bolt 2. According to the fastening system, the corrosion of the setting bolt 2 should be suppressed permanently, and the sealing element 10 is supported at a first end 11 thereof by the setting object 17 and at a second end 12 thereof by the accessory part 14 and/or the setting bolt 2 in an inserted state of the setting bolt 2 so that the sealing element 10 is extended in an axial direction.

However, such conventional inventions has a simple structure in which a lower end 22 of a fixture 20 is insertedly coupled to a fixing recess 11 formed on the top surface of a fixing plate 10 as shown in FIG. 1. Therefore, a problem occurs in that when a lateral external force is repeatedly exerted on the fixture protruded outwardly from the surface of the fixing plate 10 or the lateral external force is large, the fixing stability is deteriorated.

In an attempt to solve the above problem, the applicant has filed a patent application entitled “Strike assembly Type Fixing Device for A Shipyard” and has been granted a registration. As shown in FIG. 2, the strike assembly type fixing device for a shipyard includes: a fixing plate 10 having a fixing recess 11 formed thereon; a fixture 20 including an upper end 21 having threads formed thereon so as to be coupled with a separate fastening element 50, a lower end 22 fittingly fixed to the fixing recess of the fixing plate 10, and a protruding flange 23 formed inclinedly downwardly along an outer circumferential surface of a connection portion between the upper end 21 and the lower end 22, wherein the upper end 21, the lower end 22, and the protruding flange 23 are formed integrally with each other; and a packing ring 30 made of an elastic rubber material and fitted around the lower end 22 of the fixture 20 so as to be brought into close contact with an underside of the protruding flange 23.

However, the strike assembly type fixing device for a shipyard entails a problem in that since the fixing recess 11 is formed on the fixing plate 10 by using a drill and then the strike assembly type fixing device is struck to be fittingly fixed to the fixing recess 11, a separate process of forming the fixing recess is necessary, leading to an increase in the work time.

### DISCLOSURE OF INVENTION

### Technical Problem

Accordingly, the present invention has been made in order to solve the above-described problems occurring in the prior art, and it is an object of the present invention is to provide a fastening element for increasing fixing stability in which a drill section is formed at a bottom tip of a lower end of a fixture so that a fixing recess can be easily formed on a structure by the drill section, and in which a cut-out part is formed on the lower end of the fixture in such a manner as to be formed sharp at one side thereof and formed blunt at the other side thereof so that the fastening element can be easily screw-fastened to the fixing recess of the structure and simultaneously can be prevented from being loosened due to external vibration and the like.

Another object of the present invention is to provide a novel fastening element for increasing fixing stability in which a protrusion is formed protrudingly downwardly from an underside of a flange so that the protrusion can be pressed against a top surface of a structure to allow the fastening element to be more securely fastened to the structure.

Still another object of the present invention is to provide a novel fastening element for increasing fixing stability in which a polygonal upper flange is formed on a top surface of a flange so that a fastening part of a fixture or the upper flange can be tightened by using a wrench or the like to allow the fastening element to be easily fixedly fastened to the structure.

### Technical Solution

To achieve the above objects, the present invention provides a fastening element for increasing fixing stability, including: a fixture 20 comprising a fastening part 21, a threaded upper end 22 formed below the fixture 20, and a threaded lower end 23 formed below the upper end 22 so as to be fixedly fastened to a fixing recess 102 formed on a structure 100; a flange 30 formed extending radially outwardly from an outer circumferential surface of a connection portion between the upper end 22 and the lower end 23; and a drill section 40 formed at a bottom tip of the lower end 23 of the fixture 20 and configured to form the fixing recess of the structure 100.

In the fastening element for increasing fixing stability according to the present invention, the fixture 20 may include a cut-out part 24 formed on the lower end 23 thereof in such a manner as to be incised extending from the drill section 40 to the flange 30 at a certain angle.

In the fastening element for increasing fixing stability according to the present invention, the cut-out part 24 may include a molded sharp edge 241 formed on one side thereof so as to form the fixing recess 102 on the structure 100 and a blunt edge 242 formed on the other side thereof.

In the fastening element for increasing fixing stability according to the present invention, the flange 30 may include a protrusion 31 formed protrudingly downwardly from an underside thereof.

In the fastening element for increasing fixing stability according to the present invention, the flange 30 may include a polygonal upper flange 32 formed on a top surface thereof.

### Advantageous Effects

The fastening element for increasing fixing stability according to the present invention has effects in that the drill section is formed at the bottom tip of the lower end of the fixture so that the fixing recess can be easily formed on the structure by the drill section, and in which the cut-out part is formed on the lower end of the fixture in such a manner as to be formed sharp at one side thereof and formed blunt at the other side thereof so that the fastening element can be easily screw-fastened to the fixing recess of the structure and simultaneously can be prevented from being loosened due to external vibration and the like.

In addition, the fastening element for increasing fixing stability according to the present invention has effects in that the protrusion is formed protrudingly downwardly from the underside of the flange so that the protrusion can be pressed against the top surface of the structure to allow the fastening element to be more securely fastened to the structure.

Further, the fastening element for increasing fixing stability according to the present invention has effects in that the polygonal upper flange is formed on the top surface of the flange so that the fastening part of the fixture or the upper flange can be tightened by using a wrench or the like to allow the fastening element to be easily fixedly fastened to the structure.

### BRIEF DESCRIPTION OF THE DRAWINGS

The above and other objects, features and advantages of the present invention will be more apparent from the following detailed description of the preferred embodiments of the invention in conjunction with the accompanying drawings, in which:

FIGS. 1 and 2 are views showing a prior art technology;

FIG. 3 is a top and bottom perspective view showing a fastening element for increasing fixing stability according to a preferred embodiment of the present invention;

FIG. 4 is a front and bottom view showing a fastening element for increasing fixing stability according to a preferred embodiment of the present invention;

FIG. 5 shows top perspective views of various modifications of a fixture of a fastening element for increasing fixing stability according to a preferred embodiment of the present invention;

FIG. 6 shows a top and bottom perspective view of various modifications of a flange of a fastening element for increasing fixing stability according to a preferred embodiment of the present invention; and

FIG. 7 is a cross-sectional view showing a fastening process of a fastening element for increasing fixing stability according to a preferred embodiment of the present invention.

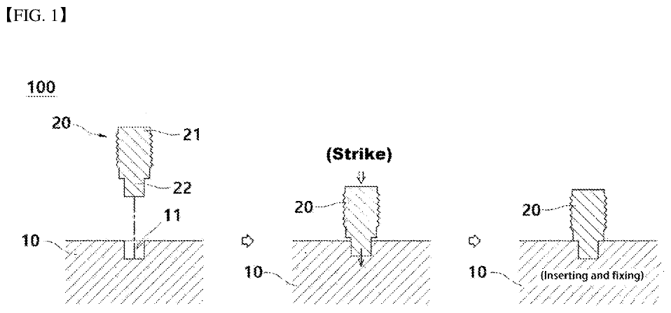

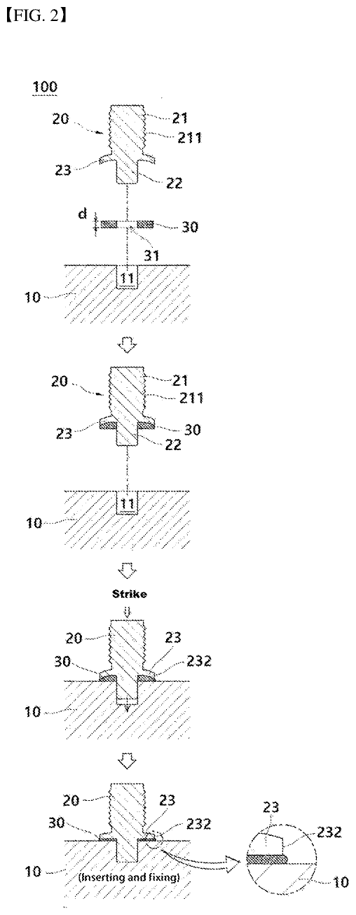

### BEST MODE FOR CARRYING OUT THE INVENTION

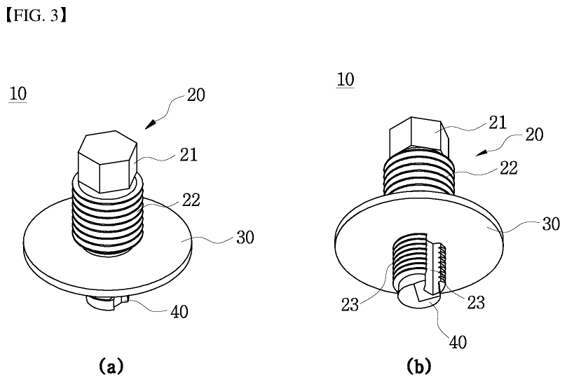

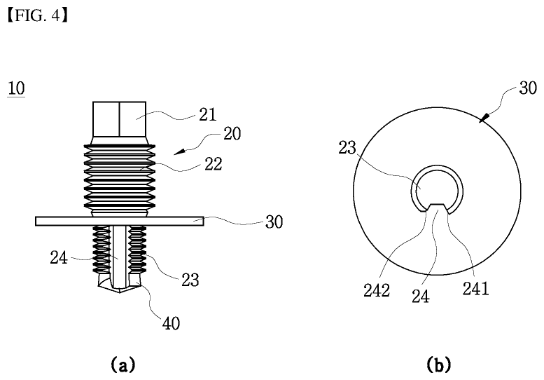

The preferred embodiment of the present invention will be described hereinafter in detail with reference to FIGS. 3 to 7. In FIGS. 3 to 7, elements of performing the same function are denoted by the same reference numerals. In the meantime, in the detailed description and the accompanying drawings, illustration and explanation on the detailed technical construction and operation of elements, which have no direct connection with the technical features of the present invention, will be omitted, and only the technical constructions directly related with the present invention will be briefly illustrated and explained.

Referring to FIGS. 3 to 7, a fastening element for increasing fixing stability according to a preferred embodiment of the present invention includes a fixture 20, a flange 30 and a drill section 40.

The fixture 20 is intended to be fixedly fastened to a fixing recess 102 of a structure 100. The fixture 20 includes a fastening part 21, a threaded upper end 22 formed below the fixture (20), and a threaded lower end 23 formed below the upper end 22 so as to be fixedly fastened to the fixing recess 102 of the structure 100. The fastening part is rotated by means of a fastening tool. The fastening tool refers to a tool such as a spanner, a wrench or the like.

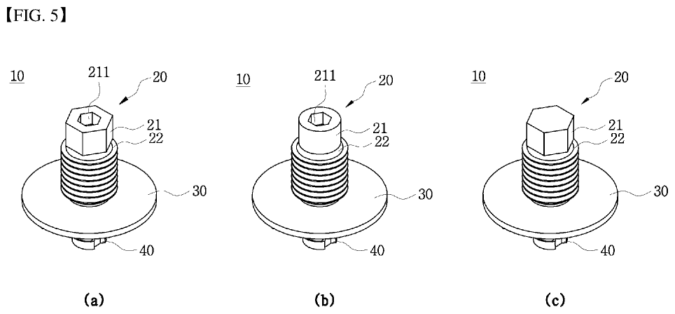

The outer circumferential surface of the fastening part of the fixture 20 is formed in a circular or polygonal shape, and the fastening part 21 has a polygonal shaped recess 211 formed therein to allow any one selected from between the circular-shaped fastening part 21 and the polygonal-shaped fastening part 21 to be rotated by the fastening tool. In other words, the fastening part 21 has a polygonal outer circumferential surface and a polygonal shaped recess 211 formed therein as shown in FIG. 5(a), has a circular outer circumferential surface and a polygonal shaped recess 211 formed therein as shown in FIG. 5(b), and has a polygonal outer circumferential surface with no recess formed therein as shown in FIG. 5(c).

The fixture 20 includes a cut-out part 24 formed on the lower end 23 thereof in such a manner as to be incised extending from the drill section 40 to the flange 30 at a certain angle. The cut-out part 24 includes a molded sharp edge 241 formed on one side thereof so as to form the fixing recess 102 on the structure 100 and a blunt edge 242 formed on the other side thereof. In other words, the sharp edge 241 is formed on one side of the cut-out part 24 to correspond to a rotational direction of the fastening element 10 so that when the fastening element 10 is rotated, a screw thread is formed on an inner circumferential surface of the fixing recess 102 of the structure 100 and simultaneously the fastening element 10 is easily fixedly fastened to the structure 100. The blunt edge 242 formed on the other side of the cut-out part 24 can prevent the fastening element 10 from being loosened with respect to the rotational direction of the fastening element 10.

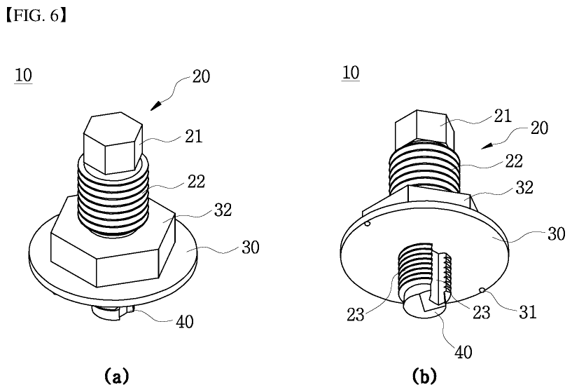

The flange 30 is formed extending radially outwardly from an outer circumferential surface of a connection portion between the upper end 22 and the lower end 23 of the fixture 20. In addition, as shown in FIG. 6, a plurality of protrusions 31 is formed protrudingly downwardly from an underside of the flange 30 and a polygonal upper flange 32 is formed on a top surface of the flange 30. In this case, the upper flange 32 has a diameter smaller than that of the flange 30 and larger than that of the upper end 22 of the fixture 20.

As described above, only the protrusions may be formed on the underside of the flange 30 or only the upper flange 32 may be formed on the top surface of the flange 30. Alternatively, the protrusions 31 and the upper flange 32 may be formed on the underside and the top surface of the flange 30, respectively.

The drill section 40 is configured to form the fixing recess 102 on the structure 100 and is formed at a bottom tip of the lower end 23 of the fixture 20.

As described above, according to the fastening element for increasing fixing stability 10 of the present invention, the drill section 40 is formed at the bottom tip of the lower end 23 of the fixture 20 so that the fixing recess 102 can be easily formed on the structure 100 by the drill section 40, and the cut-out part 24 is formed on the lower end 23 of the fixture 20 in such a manner as to be formed sharp at one side thereof and formed blunt at the other side thereof so that the fastening element 10 can be easily screw-fastened to the fixing recess 102 of the structure 100 and simultaneously can be prevented from being loosened due to external vibration and the like.

In addition, the protrusion 31 is formed protrudingly downwardly from the underside of the flange 30 so that the protrusion 31 can be pressed against the top surface of the structure 100 to allow the fastening element 10 to be more securely fastened to the structure 100.

Further, the polygonal upper flange 32 is formed on the top surface of the flange 30 so that the fastening part 21 of the fixture 20 or the upper flange 32 can be tightened by using a wrench or the like to allow the fastening element to be easily fixedly fastened to the structure 100.

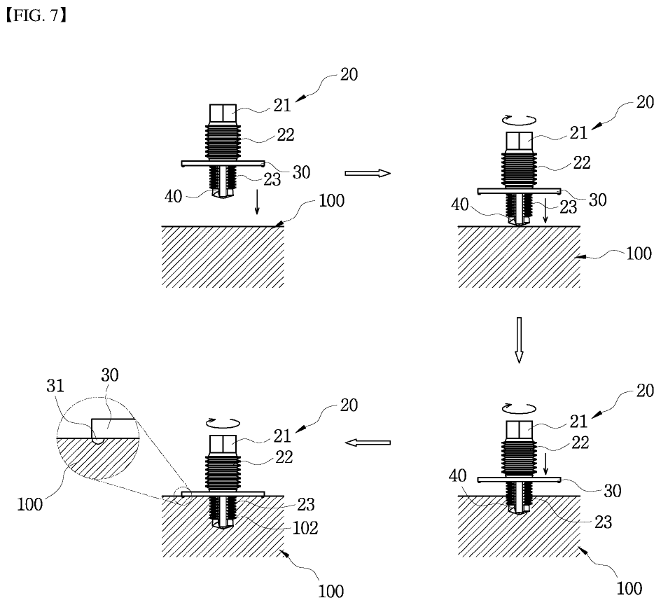

FIG. 7 is a cross-sectional view showing a fastening process of a fastening element for increasing fixing stability according to a preferred embodiment of the present invention.

Referring to FIG. 7, the position where to fasten the fastening element to the structure 100 is identified, and then the fastening element 100 for increasing fixing stability is placed at the identified position on the structure 10. Thereafter, the fastening part 21 of the fixture 20 or the upper flange 32 (not shown) of the flange is caused to be rotated by using a fastening tool. In this case, the fastening tool may be a spanner or a wrench. When the fastening element 10 is rotated by fastening tool, the drill section 40 is rotated while forming the fixing recess 102 on the structure 100, and a screw tap is formed on an inner circumferential surface of the fixing recess 102 of the structure 100 by the lower end 23 of the fixture 20 to cause the fastening element 10 for increasing fixing stability to be fixedly fastened to the fixing recess 102 of the structure 100. At this time, the protrusions 31 of the flange 30 are pressed against a top surface of the structure 100 while being brought into close contact with the top surface of the structure 100 so that the fastening element 10 is more securely fastened to the structure 100.

While the fastening element for increasing fixing stability according to a preferred embodiment of the present invention has been described and illustrated in connection with specific exemplary embodiments with reference to the accompanying drawings, it will be readily appreciated by those skilled in the art that it is merely illustrative of the preferred embodiments of the present invention and various modifications and changes can be made thereto within the technical spirit and scope of the present invention.

### Best Mode

In a best mode for carrying out the present invention, the present invention provides a fastening element for increasing fixing stability, including: a fixture 20 comprising a fastening part 21, a threaded upper end 22 formed below the fixture 20, and a threaded lower end 23 formed below the upper end 22 so as to be fixedly fastened to a fixing recess 102 formed on a structure 100; a flange 30 formed extending radially outwardly from an outer circumferential surface of a connection portion between the upper end 22 and the lower end 23; and a drill section 40 formed at a bottom tip of the lower end 23 of the fixture 20 and configured to form the fixing recess of the structure 100.

In a best mode for carrying out the present invention, the fixture 20 includes a cut-out part 24 formed on the lower end 23 thereof in such a manner as to be incised extending from the drill section 40 to the flange 30 at a certain angle.

In a best mode for carrying out the present invention, the cut-out part 24 includes a molded sharp edge 241 formed on one side thereof so as to form the fixing recess 102 on the structure 100 and a blunt edge 242 formed on the other side thereof.

In a best mode for carrying out the present invention, the flange 30 includes a protrusion 31 formed protrudingly downwardly from an underside thereof.

In a best mode for carrying out the present invention, the flange 30 includes a polygonal upper flange 32 formed on a top surface thereof.

### INDUSTRIAL APPLICABILITY

The fastening element for increasing fixing stability according to the present invention is expected to be widely used in industrial fields in that the drill section is formed at the bottom tip of the lower end of the fixture so that the fixing recess can be easily formed on the structure by the drill section, and in that the cut-out part is formed on the lower end of the fixture in such a manner as to be formed sharp at one side thereof and formed blunt at the other side thereof so that the fastening element can be easily screw-fastened to the fixing recess of the structure and simultaneously can be prevented from being loosened due to external vibration and the like.

In addition, the fastening element for increasing fixing stability according to the present invention is expected to be widely used in industrial fields in that the protrusion is formed protrudingly downwardly from the underside of the flange so that the protrusion can be pressed against the top surface of the structure to allow the fastening element to be more securely fastened to the structure.

Further, the fastening element for increasing fixing stability according to the present invention is expected to be widely used in industrial fields in that the polygonal upper flange is formed on the top surface of the flange so that the fastening part of the fixture or the upper flange can be tightened by using a wrench or the like to allow the fastening element to be easily fixedly fastened to the structure.

1. A fastening element for increasing fixing stability, comprising:
a fixture (20) comprising a fastening part (21), a threaded upper end (22) formed below the fixture (20), and a threaded lower end (23) formed below the upper end (22) so as to be fixedly fastened to a fixing recess (102) formed on a structure (100);
a flange (30) formed extending radially outwardly from an outer circumferential surface of a connection portion between the upper end (22) and the lower end (23); and
a drill section (40) formed at a bottom tip of the lower end (23) of the fixture (20) and configured to form the fixing recess of the structure (100).

2. The fastening element for increasing fixing stability according to claim 1, wherein the fixture (20) comprises a cut-out part (24) formed the lower end (23) thereof in such a manner as to be incised extending from the drill section (40) to the flange (30) at a certain angle.

3. The fastening element for increasing fixing stability according to claim 2, wherein the cut-out part (24) comprises a molded sharp edge (241) formed on one side thereof so as to form the fixing recess (102) on the structure (100) and a blunt edge (242) formed on the other side thereof.

4. The fastening element for increasing fixing stability according to claim 1, wherein the flange (30) comprises a protrusion (31) formed protrudingly downwardly from an underside thereof.

5. The fastening element for increasing fixing stability according to claim 1, wherein the flange (30) comprises a polygonal upper flange (32) formed on a top surface thereof.
